(19) United States
(12) Patent Application Publication
(10) Pub. No.: US 2009/0204909 A1
(43) Pub. Date: Aug. 13, 2009

(54) INTERACTIVE 3D ANIMATED CHARACTER DELIVERY OVER A NETWORK

(75) Inventor: Ron A. Hornbaker, San Mateo, CA (US)

Correspondence Address: FENWICK & WEST LLP, SILICON VALLEY CENTER, 801 CALIFORNIA STREET, MOUNTAIN VIEW, CA, 94041, US

(73) Assignee: FOOMOJO, INC., Redwood City, CA (US)

(21) Appl. No.: 12/370,031

(22) Filed: Feb. 12, 2009

Related U.S. Application Data
(60) Provisional application No. 61/028,152, filed on Feb. 12, 2008.

(51) Int. Cl. G06F 3/048; G06F 15/16; G06T 15/70

(52) U.S. Cl. 715/757; 345/473; 345/633

(57) ABSTRACT

Fully-rendered three-dimensional characters are delivered to a client over a network. A logic file and brief pre-rendered video clips are downloaded from a server. The video clips are downloaded only once and then cached locally for subsequent use. A software application uses the logic file to piece the video clips together in a seamless fashion to display a life-like character. The character is responsive to various trigger events, including user actions, elapsed time, and semi-random occurrences as directed by the logic file.

### CROSS-REFERENCE TO RELATED APPLICATION

This application claims the benefit of U.S. Provisional Patent Application No. 61/028,152, filed Feb. 12, 2008, which is hereby incorporated by reference in its entirety.

### BACKGROUND OF THE INVENTION

1. Field of the Invention

This invention relates in general to distribution of video content over a network and in particular to the delivery of fully-rendered interactive three-dimensional characters over a network.

2. Description of the Related Art

Virtual pets gained popularity in the 1990's as a number of companies provided increasingly sophisticated ways for users to interact with animated characters. In the beginning, virtual pets were contained on small handheld gadgets, such as Tamagotchis produced by Bandai Co., Ltd., of Tokyo, Japan, and Giga Pets produced by Tiger Electronics, now a division of Hasbro, Inc. The computing power, battery life, and display capabilities of these gadgets limited the visual effect and interactivity of these pets.

Another class of virtual pets is software based virtual pets, such as those in console-based video games that focus on the care, raising, breeding or exhibition of simulated animals. Since the computing power is more powerful in video game consoles than with gadget-based digital pets, this class of virtual pet is usually able to achieve a higher level of visual effects and interactivity.

The delivery over a network to a Web browser of fully-rendered, animated, interactive, three-dimensional characters, including virtual pets, has historically been limited by bandwidth constraints over the network and processing power constraints on the client's Web browser.

### SUMMARY OF THE INVENTION

Methods, systems, and computer-readable storage media are provided for delivering interactive, fully-rendered three-dimensional characters to a player on a client over a network. A logic file and brief pre-rendered video clips are downloaded from a server. A software application referred to herein as a “player” uses the logic file to piece the video clips together in a seamless fashion to display a life-like character. The character is responsive to various trigger events, including user actions, elapsed time, and semi-random occurrences as dictated by the logic file. The method conserves bandwidth, since the video clips are downloaded by the player only once and then cached locally for each subsequent use by the player. The method also conserves processor cycles, since the video clips are pre-rendered and delivered in plain video format to the player.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 is a high-level block diagram of a computing environment, in accordance with an embodiment.

FIG. 2 is a high-level block diagram illustrating an example of a computer for use as a server and/or client.

FIG. 3 is an illustration showing the modules of the server, in accordance with one embodiment.

FIG. 4 is an illustration showing the modules of the client, in accordance with one embodiment.

FIG. 5 is an illustration of loop clips and transition clips, in accordance with one embodiment.

FIG. 6 is an illustration of variations from a core position that may occur in response to various trigger events, in accordance with one embodiment.

FIG. 7 is a flowchart illustrating a method of delivering a fully-rendered character over a network, in accordance with one embodiment.

FIG. 8 is a flowchart illustrating the operation of the player on the client, in accordance with one embodiment.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

### 1. System Overview

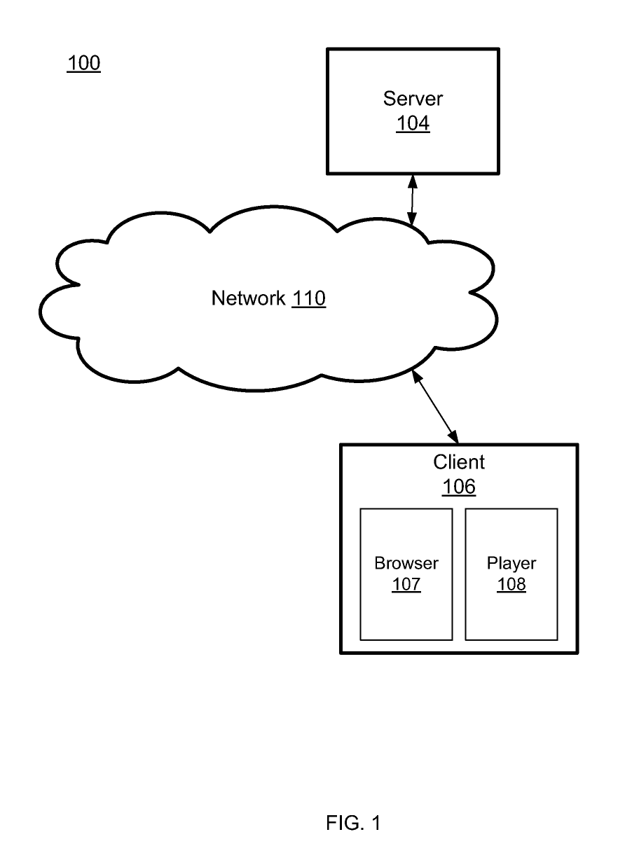

Embodiments of the invention include systems, methods, and computer-readable storage media for delivery of interactive three-dimensional animated characters over a network. FIG. 1 is a high-level block diagram of a computing environment 100, in accordance with an embodiment of the invention. The computing environment 100 includes a server 104 and one or more clients 106 connected to a network 110. The clients 106 each include a player 108 and a browser 107.

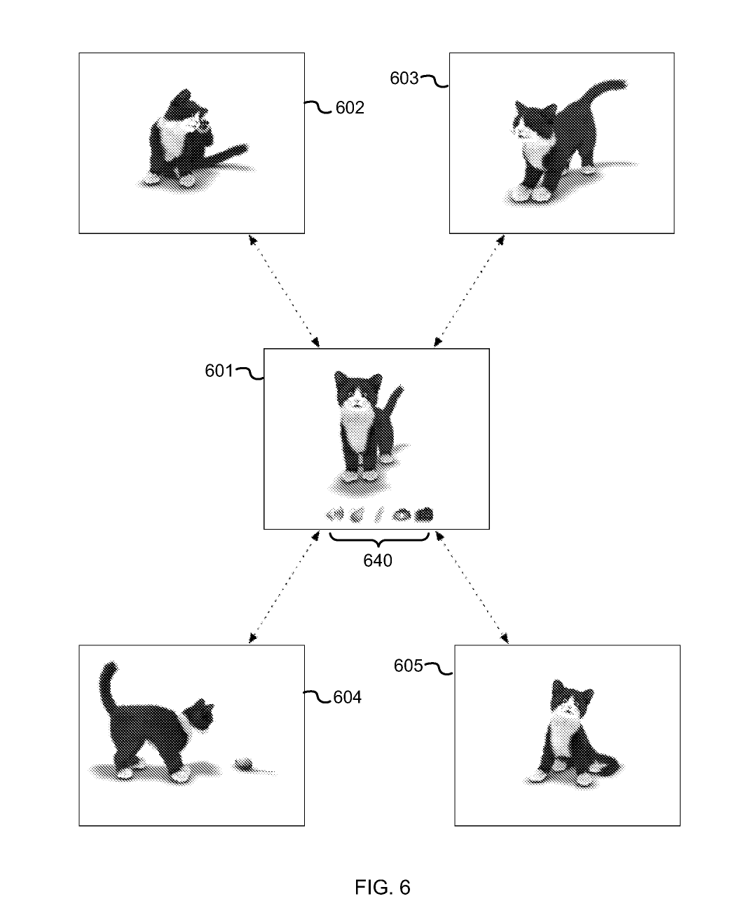

The server 104 stores data describing multiple characters, including brief video files of animated sequences of actions of each character in various positions. The server 104 also stores each character's state, such as hungry, angry, sleepy, playful, etc. The server 104 delivers over the network 110 to the player 108 the video files, the character's state, and a logic file that instructs the player 108 on the order to play the video files and the responses to trigger events. The server 104 may optionally receive information over the network 110 from the player 108 to allow measurement and collection of interactivity event data from a user's interaction with the animated character. The user's interaction with the animated character will be described below with reference to FIG. 6.

The client 106 may be any type of client device such as a personal computer, personal digital assistant (PDA), or a mobile telephone, for example. The client includes a Web browser 107 such as INTERNET EXPLORER, FIREFOX, SAFARI, OPERA, or similar software tool that makes possible the browsing of remote data and files over a network 110 such as the Internet. The client also includes a player 108 that can play video clips. In one embodiment, the player 108 is a software application running on top of a Web browser-based platform such as FLASH, SILVERLIGHT, or similar multi-media delivery mechanism. In one embodiment, the client 106 downloads the player 108 as a Shockwave Flash File (“SWF”). The SWF may be programmed using a tool like Adobe Flex or Adobe Flash, and written in code like Action Script, for example.

The network 110 represents the communication pathways between the server 104 and the client 106. In one embodiment, the network 110 is the Internet. The network 110 can also use dedicated or private communications links that are not necessarily part of the Internet. In one embodiment, the network 110 uses standard communications technologies and/or protocols. Thus, the network 110 can include links using technologies such as Ethernet, Wi-fi (802.11), integrated services digital network (ISDN), digital subscriber line (DSL), asynchronous transfer mode (ATM), etc. Similarly, the networking protocols used on the network 110 can include multiprotocol label switching (MPLS), the transmission control protocol/Internet protocol (TCP/IP), the hypertext transport protocol (HTTP), the simple mail transfer protocol (SMTP), the file transfer protocol (FTP), etc. The data exchanged over the network 110 can be represented using technologies and/or formats including the hypertext markup language (HTML), and the extensible markup language (XML). In addition, all or some of links can be encrypted using conventional encryption technologies such as the secure sockets layer (SSL), Secure HTTP and/or virtual private networks (VPNs). In another embodiment, the entities can use custom and/or dedicated data communications technologies instead of, or in addition to, the ones described above.

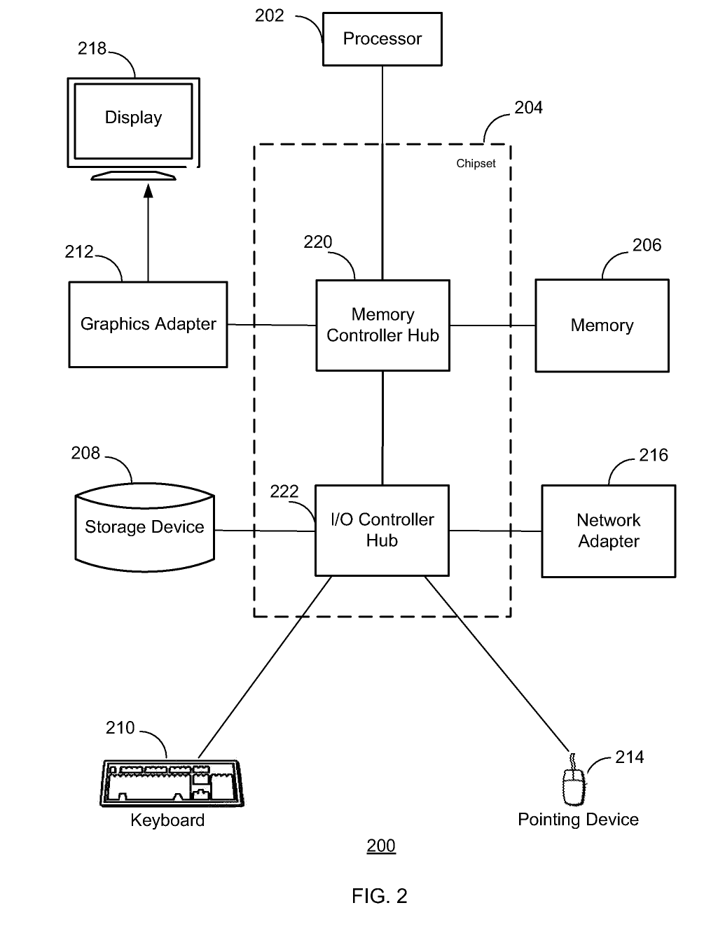

FIG. 2 is a high-level block diagram illustrating an example of a computer 200 for use as a server 104, and/or a client 106. Illustrated are at least one processor 202 coupled to a chipset 204. The chipset 204 includes a memory controller hub 220 and an input/output (I/O) controller hub 222. A memory 206 and a graphics adapter 212 are coupled to the memory controller hub 220, and a display device 218 is coupled to the graphics adapter 212. A storage device 208, keyboard 210, pointing device 214, and network adapter 216 are coupled to the I/O controller hub 222. Other embodiments of the computer 200 have different architectures. For example, the memory 206 is directly coupled to the processor 202 in some embodiments.

The storage device 208 is a computer-readable storage medium such as a hard drive, compact disk read-only memory (CD-ROM), DVD, or a solid-state memory device. The memory 206 holds instructions and data used by the processor 202. The pointing device 214 is a mouse, track ball, or other type of pointing device, and is used in combination with the keyboard 210 to input data into the computer system 200. The graphics adapter 212 displays images and other information on the display device 218. The network adapter 216 couples the computer system 200 to the network 110. Some embodiments of the computer 200 have different and/or other components than those shown in FIG. 2.

The computer 200 is adapted to execute computer program modules for providing functionality described herein. As used herein, the term “module” refers to computer program instructions and other logic used to provide the specified functionality. Thus, a module can be implemented in hardware, firmware, and/or software. In one embodiment, program modules formed of executable computer program instructions are stored on the storage device 208, loaded into the memory 206, and executed by the processor 202.

The types of computers 200 used by the entities of FIG. 1 can vary depending upon the embodiment and the processing power used by the entity. For example, a client 106 that is a mobile telephone typically has limited processing power, a small display 218, and might lack a pointing device 214. The server 104, in contrast, may comprise multiple blade servers working together to provide the functionality described herein.

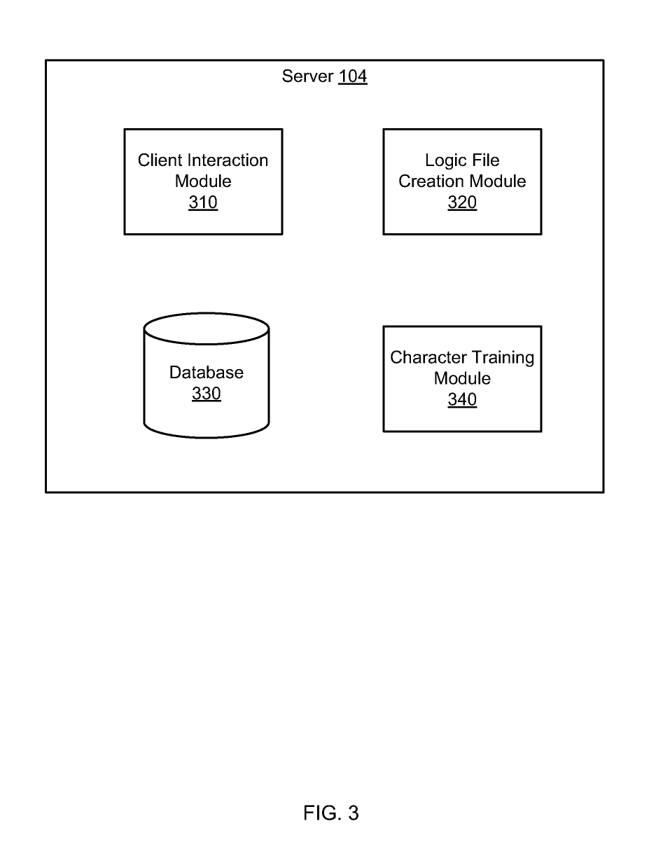

FIG. 3 is an illustration of the modules of the server 104, in accordance with one embodiment. The server includes a database 330, a client interaction module 310, a logic file creation module 320, and a character training module 340.

The database 330 stores pre-rendered video clips of animated characters and records of each character. In one implementation, each character has various individual characteristics, such as a specific date of birth, various physical characteristics (such as breed, size, gender, appearance, and the like), a personality profile, and a state (such as hungry, angry, sleepy, playful, etc.) which are all stored in the database record for the character. The database 330 may also store a user activity log and other information pertaining to the interaction of the user with the character.

The client interaction module 310 responds to requests from clients 106 for animated characters and for video clips by serving the appropriate files. The client interaction module 310 also receives interactivity reports from the clients 106 and passes them to the character training module 340.

The logic file creation module 320 is activated upon receiving a request for a character from a player 108 on the client 106. In one embodiment, the request includes a unique identifier which is used by the logic file creation module 320 to read the information in the database 330 corresponding to the unique identifier to identify the character and the state of the character. The logic file creation module 320 builds the logic file that causes the player 108 to download and play the appropriate video clips for the character in the given state. For example, a big mean Rottweiler is programmed to have aggressive growling and barking video clips commonly played, while a sedentary Basset Hound might have sleeping video clips commonly played. In one embodiment, the logic file is communicated via Extensible Markup Language (“XML”).

The character training module 340 updates the user activity log and maintains the character states stored in the database 330. The character training module 340 receives the interactivity reports as they are received through the client interaction module 310 from the players 108. In one implementation, the character training module 340 uses the interactivity reports to update the character states, personality profiles, and care schedules in the database 330.

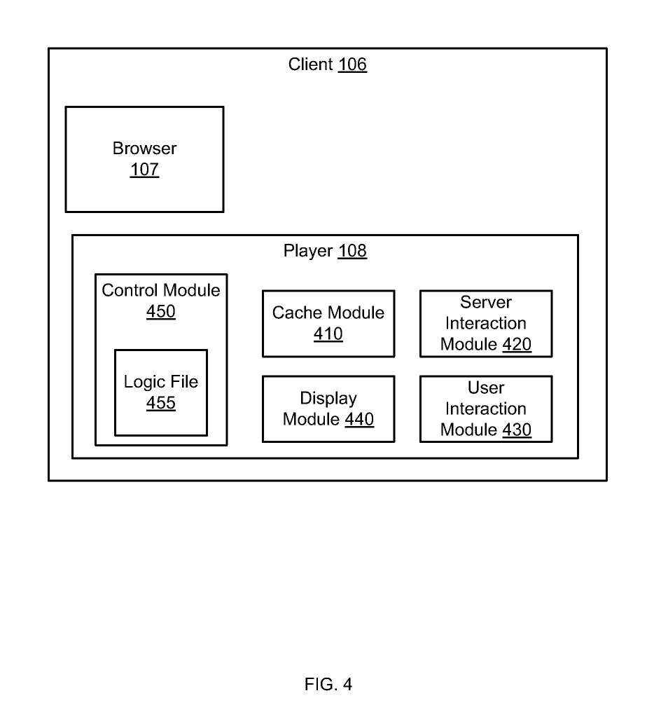

FIG. 4 is an illustration of the modules of a client 106, in accordance with one embodiment. The browser 107 and the player 108 have been described generally above. The player 108 also includes a cache module 410, a server interaction module 420, a user interaction module 430, a display module 440, and a control module 450 that uses the logic file 455 to control the character.

The cache module 410 stores downloaded video clips of the animated character received from the server 104. When a video clip is needed, the cache module 410 provides it if available in a local memory of the client 106. If a video clip is not available from the local cache, the server interaction module 420 fetches the video clip from the server 104. In some embodiments, the server interaction module 420 also sends reports the user's activity to the server 104 for use by the character training module 340, as described above.

The user interaction module 430 supports the user interaction for training and state management. The user interaction module 430 allows the direction of movement of a character by the user, which is typically accomplished with keyboard input, computer mouse input, remote control input, voice input, or touch screen capability. Examples of user interactions to which the character responds are described below with reference to FIG. 6.

The display module 440 causes video clips to be displayed on the monitor or other display 218. The display module receives the video clips for display from the cache module 410.

The control module 450 uses the logic file 455 received from the server 104 determine what video clips to display and in what order to simulate a living, responsive character for the user. The logic file 455 specifies a playlist of video clips and logic for altering the playlist of video clips in response to trigger events, which will be described in greater detail below. The control module 450 can detect when a video clip is finished playing, and can immediately start playing the next video clip in the playlist such that a character is displayed without interruption.

### 2. Pre-Rendered Video Clips

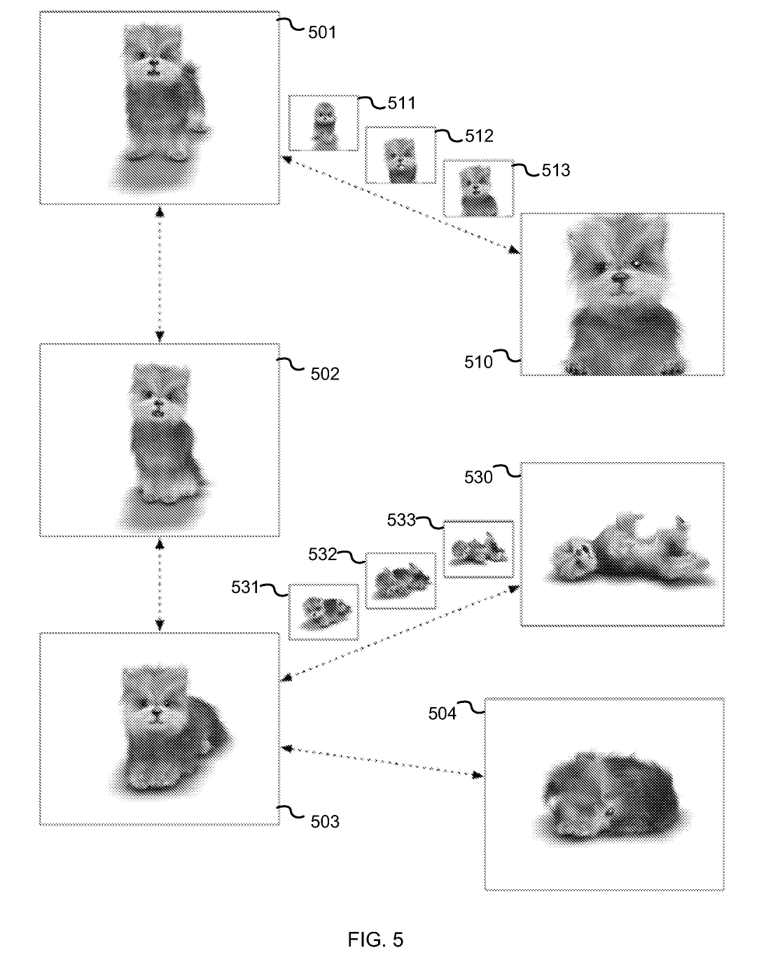

The delivery of an interactive three-dimensional animated character over a network is accomplished through delivery of brief pre-rendered video clips that are downloaded from the server 104 along with a logic file 455 used by the player 108 to piece the video clips together in a seamless fashion to simulate a life-like character. These pre-rendered video clips are described below with reference to FIGS. 5-6.

FIG. 5 is an illustration of example video clips including loop clips and transition clips, in accordance with one embodiment. Video clips are created by 3D artists using a 3D modeling and animation software tool such as MAYA, MAX3D, BLENDER, or any other similar software tool known to those of skill in the art. The video clips include video data, and may optionally include audio data as well. The video data is of an animated, three-dimensional character performing different actions. In one implementation, on the order of 200 video clips of an animated character breathing, standing, sitting, laying down, sleeping, walking, playing, eating, drinking, and undertaking various other activities are used to make the character as life-like as possible. In other implementations, more or fewer video clips can be used.

In creating loop clips, the artist ensures that that the character starts and stops from the same position. If the loop clip includes audio data, the artist ensures that the sound transitions cleanly from the end of the loop to the beginning of the loop. Thus, the loop clip can play repeatedly in a row smoothly and infinitely. The loop clips each contain a brief three-dimensional animation of a character. The pre-rendering process for each brief loop clip typically takes several minutes of workstation processing power, but need be done only once to produce a finished loop. A typical loop clip is a half second duration animation of a character standing and breathing in and out once. The loop clip may show the character's chest moving and tail wagging through one brief cycle which starts and stops in the same position, so as to repeat smoothly when looped on itself. A set of the most common postures for a character can be established as “core positions.” In one embodiment, the core positions are standing 501, sitting 502, laying down 503, and sleeping 504. In other embodiments, fewer or more core positions can be established, and they may be different than those examples shown in FIG. 5. The core positions represent character postures that allow jumping off points to smoothly connect to variations in the character's position to allow the character to seem more life-like. A variant loop might be a similar standing loop, but with the addition of an eye blink or a bark, and this loop may be included in a semi-random manner between every 10 or so typical loops to give the illusion of the character occasionally blinking or barking.

In creating transition clips, the artist ensures that the character starts from one of the core positions and ends at another. Thus, the character can smoothly transition from standing 501 to sitting 502, or between two other core positions 501-504. In some embodiments, there is a natural progression from and to the core positions. For example, in order for the character to transition from standing 501 to sleeping 504, the character transitions through sitting 502 and lying down 503. Whereas loop clips such as a character in the standing core position are typically played repeatedly back to back, the transition clips are played only once each to move between two positions.

FIG. 5 also illustrates two variations 510, 530 of two core positions 501, 503. Specifically, frame 510 illustrates an up-close position of the character, in this case a small dog. Frame 530 illustrates a belly-rub position of the character. Frames 511, 512, and 513 illustrate animation frames of the transition clip from standing 501 to the up-close position 510. Frames 531, 532, 533 illustrate animation frames from the transition clip from laying down 503 to the belly-rub position 530. The transitions out of the up-close position 510 and the belly-rub position 530, respectively, may be different transitions than those used to get in to those positions, but for simplicity, they are not shown in FIG. 5.

Once the video clips are created, they are rendered to a standard file format, for example a QuickTime Movie format. Then, using QuickTime, the file is converted to its final format as, for example, either a Flash Video file (“FLV”) or a Shockwave Flash file (“SWF”). These FLV or SWF files are the final form of the video clips, and are stored in the database 330 on the server 104.

FIG. 6 is an illustration of variations from a core position 601 that may occur in response to various trigger events, in accordance with one embodiment. Each of the frames 602, 603, 604, 605 respectively represents frames from brief video clips of character actions in response to various trigger events.

Frame 602 illustrates an ear scratch that results from a semi-random variation from the core standing position 601. The logic contained in the logic file 455 may set a frequency with which to execute the semi-random ear scratch loop 602, along with other weighted variations from the core standing position 601.

Frame 605 illustrates a sit down action that results from the expiration of a time period as tracked within the logic. The logic contained in the logic file 455 may specify how long a character will remain standing without user interaction. Once the time threshold is reached, the transition clip from the standing core position to the sitting core position is played.

Frames 603 and 604 illustrate actions of a character that are triggered by a user. Frame 603 illustrates a back scratch clip that is triggered, for example, by a user dragging the cursor over the cat's back using the pointing device 214. Frame 604 illustrates a mouse hunt that is initiated from a user's click on the mouse icon within the menu 640. In some embodiments, various user interface menu items 640 can be used by the user to initiate actions such as feeding the character and playing with the character. When any of these menu items 640 are selected, the player 108 loads and plays the appropriate video clip of the character performing the requested activity. The player 108 responds to user input from the keyboard 210, pointing device 214, or other input device such as voice/audio, remote control, touch screen, etc.

### 3. Methods of Delivering Interactive 3D Animated Characters Over a Network

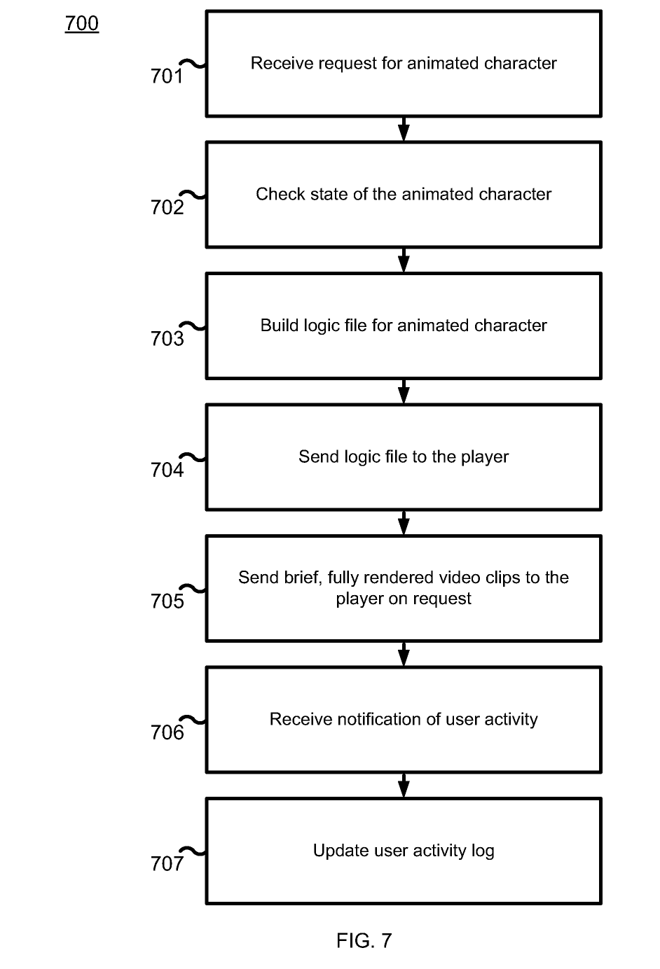

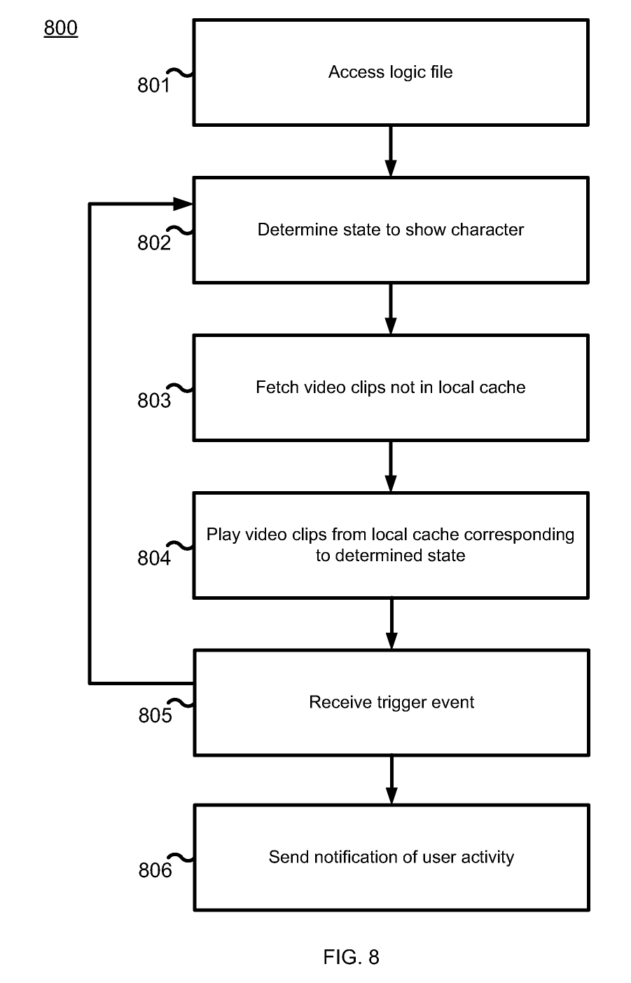

Methods of delivering interactive three-dimensional animated characters over a network will be described below with reference to FIGS. 7-8.

FIG. 7 is a flowchart illustrating a method 700 of delivering an interactive fully-rendered three-dimensional character over a network 110, in accordance with one embodiment. In step 701, the client interaction module 310 of the server 104 receives a request for an animated character from the server interaction module 420 of the player 108 on the client 106. The request may include a player identifier and/or an animated character identifier. Thus, the user may request an animated character with which the user has interacted with previously. If no character identifier is present in the request, the logic file creation module 320 of the server 104 may create a new animated character, assign it a new character identifier, and store a record of it in the database 330.

In step 702, the state of the animated character is checked by the logic file creation module 320. As described above, the character may be hungry, angry, sleepy, playful, sick, happy, or have various other temporary states that may change from time to time in a semi-random fashion, or in response to user actions. The state of the character is stored by the server 104 in the database 330.

In step 703, a logic file 455 is built for the requested animated character by the logic file creation module 320. The logic file 455 includes the state of the character and further includes a playlist of video clips and a universal resource identifier specifying a location from which each of the video clips can be downloaded as needed and cached for subsequent use by the player 108.

In step 704, the logic file is sent to the player 108 on the client 106. The operation of the player 108 on the client 106 will be described below with reference to FIG. 6.

In step 705, upon request, the client interaction module 310 of the server 104 sends the brief, fully-rendered video clips requested by the player 108 from the database 330. The player 108 only requests the video clips from the server 104 that are needed according to the logic file and are not already cached in local memory.

In step 706, the client interaction module 310 of the server 104 may optionally receive notification of user activity from the player 108. This notification allows measurement and collection of interactivity event data. This also allows a character to be “trained” by the user via tracking of the user's actions by the character training module 340 of the server 104. Thus, if notification of user activity is received in step 706, in step 707, the user activity log within the database 330 can be updated accordingly by the character training module 340. For example, if a user chooses to “feed” a character, the client interaction module 310 of the server 104 is notified by the server interaction module 420 of the player 108 via HTTP of this feeding interaction. The client interaction module 310 passes this notification to the character training module 340, and the character's state is changed in the database 330 by the character training module 340 from “hungry” to “not hungry” until sufficient time passes for the character to again be hungry.

FIG. 8 is a flowchart illustrating the method 800 operation of the player 108 on the client 106, in accordance with one embodiment. The method 800 begins in step 801 with the control module 450 of the player 108 accessing the logic file 455 received from the server 104. As described above, the logic file 455 includes the state of the animated character, and further includes a playlist of video clips and a universal resource identifier specifying a location from which each of the video clips can be downloaded as needed and cached for subsequent use by the player 108.

In step 802, the state in which to show the character is determined by the control module 450 of the player 108 from the logic file 455. As described above, the character may be hungry, angry, sleepy, playful, sick, happy, or have various other temporary states that may change from time to time in a semi-random fashion, or in response to user actions.

In step 803, the server interaction module 420 of the player 108 fetches the video clips from the playlist in the logic file 455 that are not already locally cached. For example, if the character's state according to the logic file 455 is “hungry” and the video clips corresponding to the “hungry” state are not already locally cached, then the proper video clips are downloaded from the server 104 using the universal resource identifiers for those video clips from the logic file 455. The method 800 conserves bandwidth, since the video clips are downloaded by the player 108 only once, and then cached locally for each subsequent use by the player 108. The method 800 also conserves processor cycles, since the video clips are pre-rendered and delivered in plain video format to the player 108.

In step 804, the player 108 plays video clips from the local cache corresponding to the determined state. For example, when the character is hungry, video clips will be played such as the character picking up and dropping its empty food bowl on the floor.

The method 800 will proceed as described above until, in step 805, the player 108 receives a trigger event. The logic file 455 causes the player 108 to respond to trigger events by altering the video clip sequences that are played, which furthers the illusion of a lifelike character. The trigger event can be the occurrence of a semi-random action, the expiration of an amount of time, or a user interaction such as any of those described above. The trigger event may cause a change in the character's state according to the instructions embedded in the logic file 455. For example, if a user selects a menu item 640 to feed a character, the logic file 455 may dictate that the character's state changes to “not hungry” until the expiration of a reasonable amount of time, which may be another trigger event. After the expiration of an amount of time trigger event, the character again has the state of “hungry.” As another example, the trigger event may be a semi-random occurrence specified by the logic file 455, such as the character becoming sick.

Thus, after receiving a trigger event in step 805, the state of the character may have changed. Thus, player 108 makes another determination of the state in which to show the character in step 802, and proceeds with steps 803-805 for the determined state as described above.

The method 800 may optionally include the step 806 of sending notification of user activity to the server 104. In some implementations, the notification is sent periodically from the server interaction module 420 of the player 108 throughout the user's interaction with the character. In another implementation, the notification is sent at the end of the user's interaction with the character. This optional step corresponds to step 706 of the method 700 illustrated in the flowchart of FIG. 7. When performed, this notification allows measurement and collection of interactivity event data. This also allows a character to be “trained” by the user via tracking of the user's actions over time in a user activity log in the database 330. This further promotes the bond the user feels towards the character if the user feels he has had a lasting impact on the character beyond one interactive session.

The above description is included to illustrate the operation of the embodiments and is not meant to limit the scope of the invention. From the above discussion, many variations will be apparent to one skilled in the relevant art that would yet be encompassed by the spirit and scope of the invention. Those of skill in the art will also appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of the above description present the features of the present invention in terms of methods and symbolic representations of operations on information. These descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of a method. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability. In addition, the present invention is not described with reference to any particular programming language. It is appreciated that a variety of programming languages may be used to implement the teachings of the present invention as described herein.

What is claimed is:

1. A method of delivering an interactive, fully-rendered three-dimensional character over a network to a player on a client, the method comprising:
storing a plurality of brief, pre-rendered video clips, each video clip showing a sequence of animation of a character;
storing state information describing a state of the character;
responsive to a first request from the player,
creating a logic file including the state of the character and a playlist of video clips from the plurality of stored video clips, the logic file providing instructions for causing the player to play video clips according to the playlist to simulate a life-like character, and
sending the logic file to the player;
responsive to the player executing the logic file and a user's interactions with the character, receiving a second request from the player for a video clip from the playlist; and
responsive to the second request, sending the video clip to the player.

2. The method of claim 1, further comprising:
receiving information describing user interactions with the character at the player; and
updating the state information stored in the database responsive to the received information.

3. The method of claim 1, wherein the logic file further provides instructions for causing the player to play video clips responsive to trigger events, wherein the trigger events comprise semi-random occurrences, expiration of time periods, and user interactions.

4. The method of claim 1, wherein each video clip in the plurality of brief, pre-rendered video clips is an animation of a three-dimensional character performing an action.

5. A method of delivering an interactive, fully-rendered three-dimensional character over a network to a player on a client, the method comprising:
responsive to a first request from the player, receiving a logic file including a playlist of a plurality of brief, pre-rendered video clips, each video clip showing a sequence of animation of a character, the logic file providing instructions for causing the player to play video clips according to the playlist and user interactions;
executing the logic file;
downloading video clips of the character responsive to the playlist;
displaying the downloaded video clips of the character according to the logic file instructions to simulate a life-like character;
receiving a user's interaction with the character;
responsive to the execution of the logic file and the user's interaction with the character, requesting a video clip of the character from the playlist; and
responsive to receiving the requested video clip and to the logic file instructions, displaying the requested video clip of the character.

6. The method of claim 5, wherein the logic file further provides instructions for causing the player to play video clips responsive to trigger events, wherein the trigger events comprise semi-random occurrences, expiration of time periods, and user interactions.

7. The method of claim 5, wherein each video clip in the plurality of brief, pre-rendered video clips is an animation of a three-dimensional character performing an action.

8. The method of claim 5, wherein downloading video clips of the character responsive to the playlist comprises:
storing downloaded video clips in a local cache; and
responsive to determining that a video clip from the playlist is not in the local cache, downloading the video clip.

9. A computer-readable storage medium storing executable computer program instructions for delivering an interactive, fully-rendered three-dimensional character over a network to a player on a client, the computer program instructions comprising instructions for:
storing a plurality of brief, pre-rendered video clips, each video clip showing a sequence of animation of a character;
storing state information describing a state of the character;
responsive to a first request from the player,
creating a logic file including the state of the character and a playlist of video clips from the plurality of stored video clips, the logic file providing instructions for causing the player to play video clips according to the playlist to simulate a life-like character, and
sending the logic file to the player;
responsive to the player executing the logic file and a user's interactions with the character, receiving a second request from the player for a video clip from the playlist; and
responsive to the second request, sending the video clip to the player.

10. The computer-readable storage medium of claim 9, wherein the computer program instructions further comprise instructions for:
receiving information describing user interactions with the character at the player; and
updating the state information stored in the database responsive to the received information.

11. The computer-readable storage medium of claim 9, wherein the logic file further provides instructions for causing the player to play video clips responsive to trigger events, wherein the trigger events comprise semi-random occurrences, expiration of time periods, and user interactions.

12. The computer-readable storage medium of claim 9, wherein each video clip in the plurality of brief, pre-rendered video clips is an animation of a three-dimensional character performing an action.

13. A computer-readable storage medium storing executable computer program instructions for delivering an interactive, fully-rendered three-dimensional character over a network to a player on a client, the computer program instructions comprising instructions for:
responsive to a first request from the player, receiving a logic file including a playlist of a plurality of brief, pre-rendered video clips, each video clip showing a sequence of animation of a character, the logic file providing instructions for causing the player to play video clips according to the playlist and user interactions;
executing the logic file;
downloading video clips of the character responsive to the playlist;
displaying the downloaded video clips of the character according to the logic file instructions to simulate a life-like character;
receiving a user's interaction with the character;
responsive to the execution of the logic file and the user's interaction with the character, requesting a video clip of the character from the playlist; and
responsive to receiving the requested video clip and to the logic file instructions, displaying the requested video clip of the character.

14. The computer-readable storage medium of claim 13, wherein the logic file further provides instructions for causing the player to play video clips responsive to trigger events, wherein the trigger events comprise semi-random occurrences, expiration of time periods, and user interactions.

15. The computer-readable storage medium of claim 13, wherein each video clip in the plurality of brief, pre-rendered video clips is an animation of a three-dimensional character performing an action.

16. The computer-readable storage medium of claim 13, wherein the computer program instructions for downloading video clips of the character responsive to the playlist comprise instructions for:
storing downloaded video clips in a local cache; and
responsive to determining that a video clip from the playlist is not in the local cache, downloading the video clip.
